(19) United States
(12) Patent Application Publication
(10) Pub. No.: US 2013/0015125 A1
(43) Pub. Date: Jan. 17, 2013

(54) METHOD AND DEVICE FOR BIOLOGICAL WASTEWATER PURIFICATION

(71) Applicant: Kurt Ingerle, Gotzens (AT)

(72) Inventor: Kurt Ingerle, Gotzens (AT)

(21) Appl. No.: 13/576,139

(22) PCT Filed: Jan. 5, 2011
(86) PCT No.: PCT/AT2011/000001

§ 371 Date: Oct. 4, 2012

(30) Foreign Application Priority Data
Jan. 28, 2010 (AT) A 116/2010

(51) Int. Cl. C02F 9/14

(52) U.S. Cl. 210/609

(57) ABSTRACT

The present invention relates to the biological purification of wastewater by means of activated sludge, wherein the wastewater is first introduced into an activated-sludge tank (B tank) that can be ventilated and then is introduced into one of two sedimentation and recirculation tanks (SU tanks) in alternation, the sedimentation and recirculation tanks being continuously connected hydraulically to the B tank. In the sedimentation and recirculation tanks, the activated sludge and the treated water are separated by sedimentation (V phase), and thereafter activated sludge is fed back into the B tank (S phase). Then the contents of the SU tank are mixed (U phase). Finally, the treated water is drawn off (A phase). The cycles in the SU tanks are phase-shifted and the A phases border on each other so that there is flow through the SU tanks only in the A phases, an approximately constant water level is present, and thus a wastewater treatment plant discharge corresponding to the wastewater treatment plant supply develops (continuous flow principle). In order for the thickened sludge fed back from the SU tank into the B tank not to flow back into the SU tank (S phase), two ventilation fields are provided in the B tank, wherein in the S phases, only the ventilation field adjacent to the SU tank in which the S phase is miming is operated.

The present invention relates to a method for carrying out biological purification of communal or similar wastewater with the aid of activated sludge according to the preamble of claim 1, and to a device for carrying out this method.

A method for biological purification of wastewater with the aid of activated sludge, in which the wastewater is first introduced into an activated sludge tank that can be ventilated and then into a sedimentation tank, in which activated sludge and treated water are separated and, after the separation process, activated sludge is fed back into the activated sludge tank and treated water is drawn off, is known from European patent EP 0 851 844. A number of operating cycles are carried out in the sedimentation tank over the course of a day and comprise a stirring phase U, a pre-sedimentation phase V and a draw-off phase A, wherein, in the stirring phase, the activated sludge is again mixed with the water, in the pre-sedimentation phase the activated sludge is sedimented, and in the draw-off phase treated water is drawn off. In accordance with the method according to this document, the purification process takes place in a biological twin-tank system that is to say in the activated sludge tank and in the sedimentation tank, with continuous inflow and intermittent outflow. During the period of no outflow, the water level increases as a result of the inflow (filling principle). The patent claim of this method consists in the fact that sedimented activated sludge is returned to the activated sludge tank of the “twin-tank system with filling operation” after the pre-sedimentation phase and before the stirring phase. In the stirring phase, the contents of the B tank (activated sludge tank) are mixed with the contents of the SU tank (sedimentation tank) until a largely constant dry substance concentration is obtained. Both tanks border one another and are continuously interconnected hydraulically in the base region.

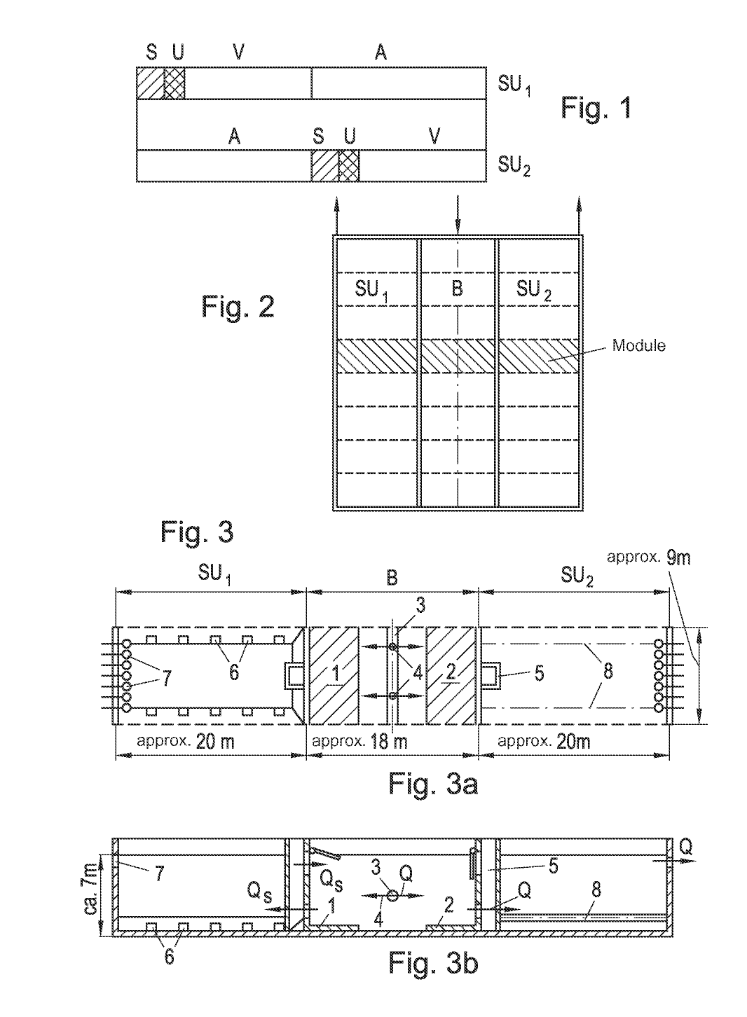

A similar method is known from international patent PCT/AT00/00322, in which sedimented, thickened activated sludge is returned from the SU tanks into the B tank after the V phases, but before the U phases. The B tank is continuously connected hydraulically to two SU tanks by one or more openings in the central region of the tank (FIG. 1), and the cycle times are selected to be approximately 140 minutes (S phase approximately 5 min; U phase approximately 5 min; V phase approximately 60 min; A phase approximately 70 min, A=(S+U+V)). In the S phase, thickened sludge is conveyed from the base of the SU tanks into the upper region (close to the surface) of the B tank, and the contents of the B tank thus displaced are returned via the openings in the central region of the tank. In the U phase, the contents of the SU tank are swirled and homogenized, without generation of a circulating flow via the B tank. In the A phase, there is a flow from the B tank into the SU tank, likewise through the openings in the central region. The stirring in the SU tanks (U phase) is achieved by blowing in air.

The object of the present invention is to improve or complement the method described in the introduction for biological wastewater purification in such a way that an application for medium and large wastewater treatment plants is also made possible due to the use of the module principle, without development of short-circuiting flows of the thickened activated sludge (S phase) in the B tank and of the crude wastewater introduced continuously into the B tank. This object is achieved by a method having the features of claim 1 and by a device for carrying out this method. Advantageous developments of the invention are disclosed in the dependent claims.

In order to save space, costs and energy, the module system is applied in large wastewater treatment plants. A relatively large number of modules, consisting of a B tank and two SU tanks arranged on the opposite sides of the B tank (FIGS. 2 and 3) are combined to form a wastewater treatment system path. By combining up to 10 modules (and possibly more), a very long and narrow B tank is created, in which there is a risk that short-circuiting flows of the thickened activated sludge may develop in the S phase, as well as short-circuiting flows of the wastewater fed continuously for purification. A known possibility for solving this problem lies in forming the B tank as an activated sludge tank with circulating flow. This solution is problematic in terms of the S and A phases, since the individual modules can no longer be operated independently of one another, thus resulting in the development of different conditions with regard to dry substance values, purification efficiency and hydraulic load. In addition, the walls required to guide the flow and the continuously running stirring units are very detrimental to the energy balance and to costs.

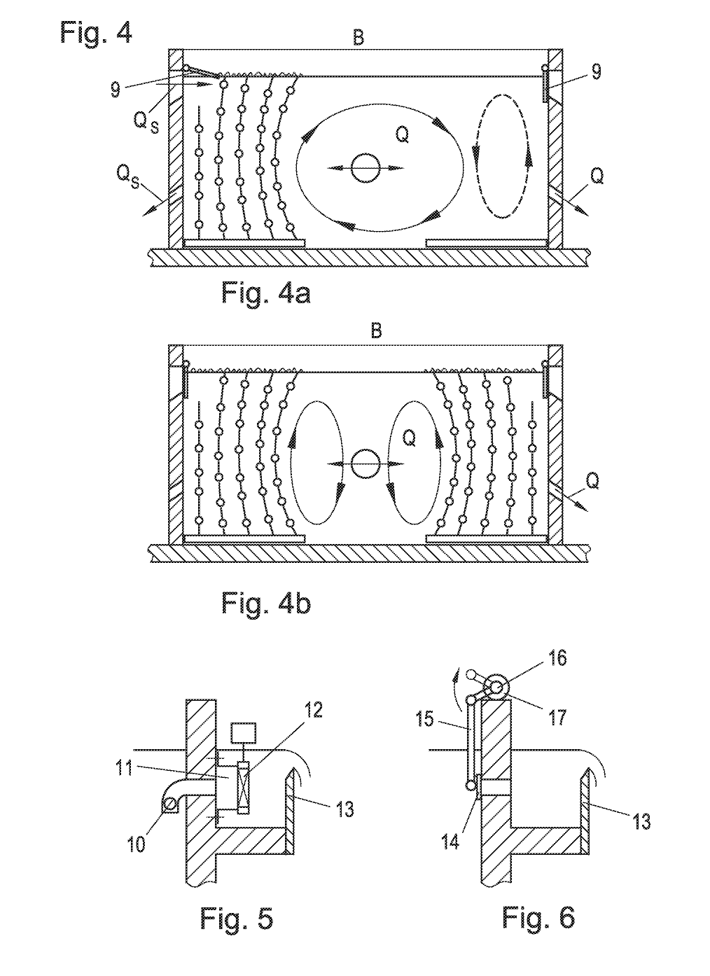

One aspect of the invention therefore lies in solving the problem of returning the thickened activated sludge from the SU tank into the B tank (S phase) in such a way that there is no short-circuiting flow. After entry into the B tank, the thickened sludge cannot arrive back in the SU tank over a short path, since the sludge return would otherwise be disturbed, the dry substance in the B tank would fall sharply and purification would no longer be efficient. In accordance with this aspect of the invention, the solution to this problem lies in the arrangement of two ventilation fields 1 and 2 (mostly fine bubble ventilation) in the B tank, at the edges bordering the SU tanks, said ventilation fields being operable together or separately depending on the requirements of the process. A ventilation-free region (approximately one third of the tank width) remains in the centre of the tank. In accordance with the invention, merely the ventilation field which borders the SU tank in which the S phase takes place is operated during the S phase. A vertical hydraulic flow, which guides the thickened sludge Q, coming from the SU tanks into the opposite half of the B tank and thus prevents a short-circuiting flow (see FIG. 4), thus develops in the B tank. Q, is approximately ten times greater than Q.

It is also possible for more than two ventilation fields to be provided, for example four, six, eight, twelve or sixteen ventilation fields, which, preferably arranged in pairs, each supply one or more modules.

Yet another aspect of the invention concerns the problem of introducing the wastewater to be purified Q into the B tank in such a way that there is no drifting of the wastewater, which is still purified insufficiently, into the SU tanks, the B tank and all modules are subject to equal hydraulic load, and constant conditions are obtained in the two SU tank units of a module. Care should also be taken to ensure that the flow conditions in the S phase (large vertical hydraulic flow) are not disturbed and that there is no constant depositing of activated sludge in the unventilated region of the B tank. In accordance with this aspect of the invention, in order to solve this problem, the wastewater to be purified is fed via one or more horizontal pipelines, which extend in the longitudinal direction of the B tank, are situated in the centre of the tank at approximately half the water depth, and have openings. The openings will preferably be arranged in such a way that the wastewater can escape horizontally in both directions and uniform coating of the B tank and modules is possible (FIG. 3). When the U and V phases are in progress, both ventilation fields are to be operated identically (either different air feed or intermittent ventilation). Optimal mixing of the contents of the B tank in these phases with good biochemical purification is thus achieved.

With this solution, laying the pipes directly on the base of the B tank is detrimental to the formation of the hydraulic in the S phase and leads to undesired sludge deposits. A free throughflow should be ensured beneath the pipelines.

In principle, it is also possible to lay the pipes for the wastewater feed directly on the base of the B tank and to lead the ventilation fields as far as these pipes. This solution requires more ventilators and is correspondingly expensive.

Depending on the arrangement of the SU tanks (side by side or opposite), a wastewater feed adapted thereto so as to prevent short-circuiting flows is provided in the B tank.

The present invention can also be used when both SU tanks are arranged on one side of the B tank. One ventilation field borders the SU tanks, the other lies on the opposite side of the B tank. In the S phase, only the ventilation field bordering the SU tanks is operated.

It is particularly cost-effective and energy-saving if the thickened sludge (S phase) is returned using air lift pumps and if compressed air is likewise used to recirculate the contents of the SU tanks (U phase). The compressed air provided for ventilation of the B tanks is also suffice for this.

Different devices can be used for the draw-off of the treated wastewater. Two devices are illustrated in FIGS. 5 and 6. It is also noted that a large part of the nitrate concentration is found in the SU tanks (endogenous dentrification) with this method. The excess sludge is drawn off from the base of each of the SU tanks before the S phases begin. The activated sludge is then thickened to the greatest possible extent.

Excellent purification with a very low energy requirement and low costs is achieved as a result of the balanced water level in the B tank and in the SU tanks, as a result of the lack of continuously running electric pumps and stirring units, as a result of the use of compressed air for operation of the S and U phases (simultaneous entry of oxygen) and as a result of the extensive (endogenous) dentrification.

Further details of the present invention will emerge from the following drawings, which illustrate an exemplary, non-limiting embodiment of the invention. In the drawings:

FIG. 1 shows the operating cycle for the two SU tanks in the exemplary embodiment;

FIG. 2 shows a schematic illustration of a wastewater treatment system path in the exemplary embodiment, consisting of eight modules;

FIGS. 3a and 3b show, respectively, an outline and a vertical sectional view of a module of FIG. 2 (S phase);

FIGS. 4a and 4b show, respectively, the flow conditions in the B tank, wherein one ventilation field is in operation in FIG. 4a (S phase), and both ventilation fields are in operation in FIG. 4b (U and V phases);

FIG. 5 shows a treated water draw-off with ball elements; and

FIG. 6 shows a treated water draw-off with a flat side valve chain.

FIG. 1 shows an operating cycle in the two SU tanks SU₁ and SU₂, wherein time extends in the horizontal direction from left to right. The course and function of the individual phases have already been discussed above in greater detail.

FIG. 2 illustrates a schematic view of the outline of a wastewater treatment system path, consisting of eight modules. One of the modules is highlighted by hatching.

FIGS. 3a and 3b show a schematic outline and a vertically extending sectional view of a module (along a line which, in FIG. 2, extends horizontally through a module). The components 1 and 2 signify the two ventilation fields, 3 signifies the pipeline for feeding the wastewater to be purified Q, 4 signifies the openings for uniform coating of the B tank with the wastewater Q, 5 signifies the air lift pump for operation of the S phase, 6 signifies the lines at the base for draw-off of the thickened sludge Qₛ, 7 signifies the treated water draw-off (ball elements), and 8 signifies the line for recirculation of the contents of the SU tanks.

FIGS. 4a and 4b show schematic vertical sectional views through a B tank with ventilation fields according to the invention. In FIG. 4a, the flow conditions with operation of one ventilation field (S phase) are illustrated; and in FIG. 4b with operation of both ventilation fields (U and V phase). Reference signs 9 denote the flap valves of the air lift pumps.

FIG. 5 illustrates a schematic view of a treated water draw-off with ball valve elements. The treated water flows in succession through ball valve elements 10, which only open in the A phases, then through a collecting main 11 and an electric closure 12. Lastly, a weir 13 fixes the minimum water level in the tank.

FIG. 6 also illustrates a system for the treated water draw-off, said system consisting of numerous outflow openings of approximately 150 mm arranged approximately 30 cm below the minimum water level and at a distance of approximately 1.50 m, said outflow openings being opened and closed by means of vertically displaceable closure plates 14. These closure plates are moved by rods 15 provided with springs and are pressed simultaneously against the outflow openings. The openings are ultimately opened and closed by a rotating horizontal shaft 16, which is driven by a motor 17 adapted to the requirements.

1. A method for carrying out biological purification of wastewater with the aid of activated sludge, comprising:
introducing wastewater into an activated sludge tank and then, in alternation, into one of a number of sedimentation and recirculation tanks continuously connected hydraulically to the activated sludge tank; and
performing a number of operating cycles over a course of a day including a sludge return phase, a recirculation phase, a pre-sedimentation phase and a draw-off phase,
wherein in the sludge return phase, the thickened sludge is returned in succession from the sedimentation and recirculation tanks into the activated sludge tank;
wherein in the recirculation phase, the activated sludge is again mixed with the water;
wherein in the pre-sedimentation phase, the activated sludge is sedimented; and
wherein in the draw-off phase, treated water is drawn off,
wherein in the sedimentation and recirculation tanks, the cycles are phase-shifted in relation to one another;
wherein a flow passes through the sedimentation and recirculation tanks merely in the draw-off phases,
wherein the activated sludge tank comprises at least two ventilation fields;
wherein in the sludge return phases, only the ventilation field bordering the SU tank in which a sludge return phase has just taken place is operated alone; and
wherein in the pre-sedimentation and recirculation phases the two ventilation fields are used.

2. The method according to claim 1, wherein:
the activated sludge tank is continuously connected hydraulically to the sedimentation and recirculation tanks by one or more openings in the central region of the tank;
in the sludge return phase, thickened sludge is pumped out from the base of the sedimentation and recirculation tanks, is conveyed into the upper region of the activated sludge tank, and the contents of the activated sludge tank thus displaced are returned via the openings in the central region of the tank;
in the recirculation phase, the contents of the sedimentation and recirculation tanks are swirled and homogenized, without generation of a circulating flow via the activated sludge tank; and
in the draw-off phase, there is a flow from the activated sludge tank into the sedimentation and recirculation tanks, likewise through the openings in the central region.

3. The method of claim 1, wherein ventilation fields with fine bubble ventilation are used.

4. The method of claim 1, wherein:
a geometry with sedimentation and recirculation tanks arranged on two opposite sides of the activated sludge tank is used, and
the ventilation fields come to lie so as to directly border the sedimentation and recirculation tanks, are of equal size, and a vent-free region is formed between the ventilation fields.

5. The method of claim 1, wherein a geometry of the sedimentation and recirculation tanks with sedimentation and recirculation tanks arranged on the two opposite sides of the activated sludge tank is used, wherein both ventilation fields are of equal size and cover the base area of the activated sludge tank preferably completely, excluding the region occupied by a supply line.

6. The method of claim 1, wherein:
a geometry of the sedimentation and recirculation tanks with sedimentation and recirculation tanks arranged on the two opposite sides of the ventilated activated sludge tank is used;
the wastewater to be purified flows into the activated sludge tank via one or more horizontal lines, which extend in the longitudinal direction of the activated sludge tank.

7. The method of claim 5, wherein the wastewater to be purified flows into the activated sludge tank via one or more horizontal lines, which extend in the longitudinal direction of the activated sludge tank at the base thereof.

8. The method of claim 1, wherein:
two sedimentation and recirculation tanks are situated side by side on one side of the activated sludge tank;
one ventilation field borders the sedimentation and recirculation tanks, and the other comes to lie on the opposite side and the ventilation field bordering the sedimentation and recirculation tanks is operated when the sludge return process takes place in an sedimentation and recirculation tank.

9. The method of claim 1, wherein the sludge is returned from the sedimentation and recirculation tanks into the activated sludge tank by means of air lift pumps, which are supplied for a short time with compressed air.

10. The method of claim 1, wherein: the contents of the sedimentation and recirculation tanks are recirculated by means of compressed air, which is provided for ventilation of the activated sludge tank; and
perforated pipes are used forming vertical hydraulic flows in the sedimentation and recirculation tanks.

11. The method of claim 1, wherein the treated water is drawn in approximately 20 cm below the minimum water level and flows out in succession via ball valve elements, via collecting mains, via electrically driven closure members and via weir structures.

12. The method of claim 1, wherein a number of outflow openings are provided for the treated water draw-off, said outflow openings being openable and closable by a system comprising displaceable closure members, rods which connect said closure members and a drive.

13. (canceled)

14. The method of claim 1, wherein the two ventilation fields are used during the pre-sedimentation and recirculation phases intermittently.
